(19) United States
(12) Patent Application Publication
(10) Pub. No.: US 2012/0218076 A1
(43) Pub. Date: Aug. 30, 2012

(54) WIRELESS CAPABLE SECURITY DOOR ANTENNA

(76) Inventor: Joseph Zacchio, Wethersfield, CT (US)

(21) Appl. No.: 13/504,207

(22) PCT Filed: Oct. 28, 2009
(86) PCT No.: PCT/US2009/005846

§ 371 Date: Apr. 26, 2012

(51) Int. Cl. G05B 19/00; H01Q 1/00

(52) U.S. Cl. 340/5.61; 343/720

(57) ABSTRACT

A door security system comprises a door, and a handle assembly attached to the door. The handle assembly includes a lock mechanism, a handle, and an escutcheon. The lock mechanism has an unlocked state and a locked state for securing access to the door, and the handle is rotatably supported by the handle assembly as a means of access through the door when the lock mechanism is in the unlocked state. At least one of the handle and the escutcheon acts as an antenna capable of wirelessly receiving and transmitting radio frequency signals and capable of communicating with the lock mechanism to switch the lock mechanism between the unlocked and locked state.

### BACKGROUND

This invention relates to security systems and more particularly relates to wireless locks for door security systems.

Facilities that have a large number of inside doors include hotels and commercial buildings. Quite frequently, these types of facilities require a security system put in place to grant or deny access through individual doors inside the facility. A common lock assembly fitted to the doors includes a locking mechanism, a handle or knob on either side of the door, and an escutcheon or metal plate on either side of the door to cover and protect the handles and locking mechanism. These assemblies are typically fitted into routed cavities in the doors. All locking mechanisms have some sort of an unlocked state in which a user is allowed to open the door and a locked state in which a user is prevented from opening the door. The conventional locking mechanism is provided with a latch, which is actuated by the handle or knob. The conventional locking mechanism also includes a deadbolt which, when engaged, prevents access through the door.

Some facilities rely on the method of a user controlled key in conjunction with the locks in order for a user to access certain doors. These keys can range from conventional metal keys used with cylinder locks to more modern magnetic-stripe keycards that pair with a reader on the lock mechanism. Another method of security is a numeric keypad adjacent to the door into which a user can type a code that will unlock the door and allow access.

As security measures become more modernized, facilities can implement a remote system in addition to, or in place of, the user-centered systems of door control. The door lock assemblies need to have an antenna that is capable of communicating wirelessly with a controller. If a smaller antenna is used with the existing lock assembly and cavity, the efficiency of the antenna's electromagnetic (EM) radiation will not be very good. It is possible to rout a larger cavity so that a much larger antenna can be placed within the door in conjunction with the lock assembly, but commercial doors are often made out of wood or metal so retrofitting them can be costly. In addition, an antenna contained within a door's cavity, regardless if the cavity has been enlarged or not, has to permeate the door's material acting as a barrier to efficient EM radiation. Wood doors gather moisture and hinder antenna performance by absorption, refraction reflection of the EM wave. The metal doors are a shield for the transmission of EM waves. In light of this, repeaters are often placed in a building's hallways as a means of boosting the wireless performance of these door lock systems.

There exists a need to boost the performance of wireless door security systems while eliminating excessive repeaters and keeping the cost down (i.e. building new doors or retrofitting existing doors).

### SUMMARY

Another aspect of the invention is a door security system comprising a control module, a door, and a handle assembly attached to the door. The handle assembly includes a lock mechanism with an unlocked state and a locked state for securing access to the door, a handle rotatably supported by the handle assembly as a means of access through the door when the lock mechanism is in the unlocked state, and an escutcheon. At least one of the handle and the escutcheon acts as an antenna wirelessly communicating with the control module and communicating with the lock mechanism to switch the lock mechanism between the unlocked and locked state.

Another aspect of the invention is a door security system comprising a door, a housing attached to the door, a handle, and a control module. The housing includes a lock mechanism for securing access to the door and has an unlocked state and a locked state. The handle is rotatably supported by the housing, and acts as a means of access through the door when the lock mechanism is in the unlocked state. The handle further acts as an antenna capable of sending and receiving radio signals. The control module is capable of sending and receiving radio frequency signals to and from the handle to switch the lock mechanism between the unlocked and the locked states.

### BRIEF DESCRIPTION OF THE DRAWINGS

FIG. 1 is a diagrammatical view of a wireless door security system.

FIG. 2 is a block diagram of the wireless door security system of FIG. 1.

FIG. 3 is an exploded perspective view of a remote access control system of the wireless door security system.

FIGS. 4A and 4B are alternative methods of electrically isolating a handle for use as an antenna in the wireless door security system.

FIG. 5 is another embodiment of a remote access control system of the wireless door security system.

### DETAILED DESCRIPTION

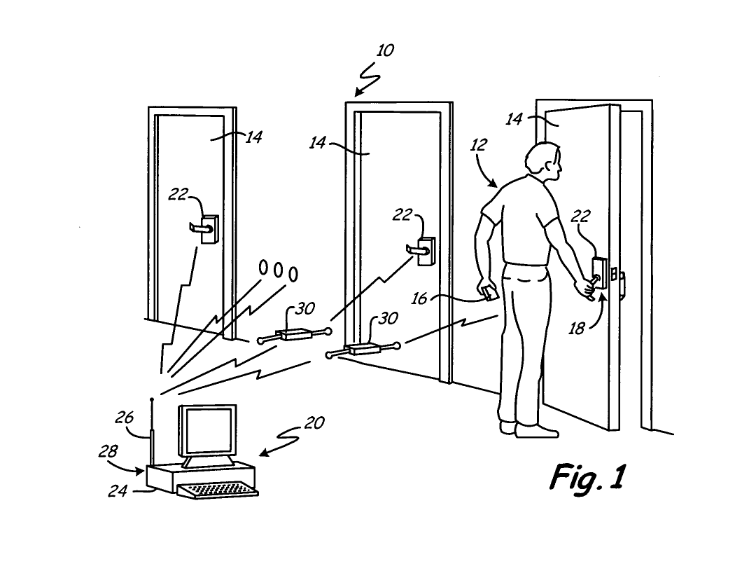

In FIG. 1, wireless door security system 10 is shown and includes a plurality of doors 14, key 16, lock mechanism 18, central control module 20, and a plurality of remote access control systems 22 mounted on the plurality of doors 14. Door security system 10 controls whether user 12 will be granted or denied access through a particular door 14. One way user 12 is granted access through door 14 is by presenting a valid key 16 to remote access control system 22 mounted on door 14 or within lock mechanism 22, which unlocks lock mechanism 18 and allows user 12 to open door 14 and pass through. Key 16 is typically a type of card with data stored on it; the data are usually stored in the form of a magnetic stripe that remote access control system 22 is capable of reading and determining whether the data stored on key 16 are valid.

Wireless door security system 10 includes central control module 20 and a plurality of remote access control systems 22 located remotely from central control module 20. Central control module 20 uses wireless communication technology to communicate with each remote access control system 22. Central control module 20 can be used to program each remote access control system 22 so that certain users 12 are granted access through certain doors 14 and other users 12 are granted access through other doors 14. With what is effectively a “lockdown” mode, central control module 20 can also deny access through any number or all of doors 14 regardless of whether user 12 presents key 16 that is normally valid. Central control module 20 can also receive information from each remote access control system 22 so that user access information such as the time and date that particular user 12 was granted access through door 14 can be tracked and monitored.

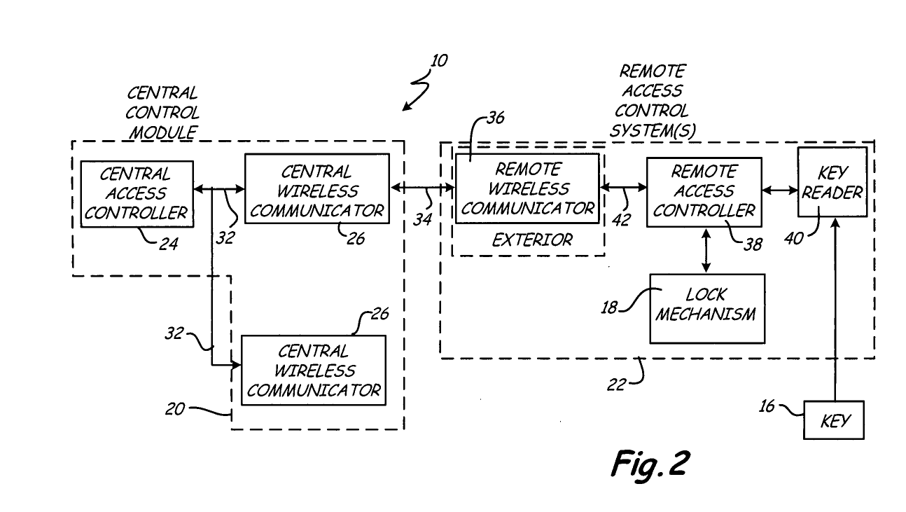

As shown illustratively in FIG. 1 and diagrammatically in FIG. 2, central control module 20 includes central access controller 24, central wireless communicator 26, and power and/or signal bus 28 that electrically interconnects central access controller 24 and central wireless communicator 26. Central wireless communicator 26 allows information to be communicated wirelessly between central access controller 24 and each remote access control system 22. In some cases, such as where door 14 is located substantially far away from central control module 20, repeaters 30 help amplify the wireless communication between central control module 20 and remote access control system 22. These repeaters 30 are, for example, mounted in the hallways of a large building in which door security system 10 is installed. Central access controller 24 is configured to communicate bidirectionally with one or more central wireless communicators 26, as shown in FIG. 2 by double-headed arrow 32 interconnecting central access controller 24 and central wireless communicator 26. This bidirectional communication allows information to be transmitted from central access controller 24 to central wireless communicator 26 and/or received by central access controller 24 from central wireless communicator 26.

Each remote access control system 22 is configured to communicate wirelessly and bidirectionally with central wireless communicator 26 of central control module 20, as shown in FIG. 2 by double-headed arrow 34 interconnecting central wireless communicator 26 and remote access control system 22. A portion of each remote access control system 22 is mounted within the lock mechanism 18 and includes remote wireless communicator 36, remote access controller 38, key reader/user input device 40. Remote wireless communicator 36 is configured to communicate information wirelessly and bidirectionally to and from central wireless communicator 26. Remote access controller 38 is configured to communicate bidirectionally with remote wireless communicator 36 as indicated by double-headed arrow 42. Therefore, remote access controller 38 can send or receive information to or from central access controller 24 through remote and central wireless communicators 36 and 26. This allows remote access controller 38 to send user access information to central access controller 24 while also allowing central access controller 24 to change the programming of remote access controller 38 by, for instance, determining which keys 16 have access to which doors 14.

Key reader 40 is configured to read data stored on key 16 and transmit the data to remote access controller 38. If the data from key 16 are determined by remote access controller 38 to be valid, remote access controller 38 will send an “unlock” signal to lock mechanism 18 mounted to door 14. With lock mechanism 18 in an unlocked state, user 12 is able to open door 14. Key reader 40 can be a card reader as shown in FIG. 1, or it can be any other device which interprets key data to permit an authorized user to access a controlled door. A few examples of what key reader 40 may be are: a keypad, a fingerprint reader, and a voice recognition device. In those cases, key 16 would respectively be: the code of numbers user 12 punches into the keypad, the fingerprint of user 12, and the voice of user 12.

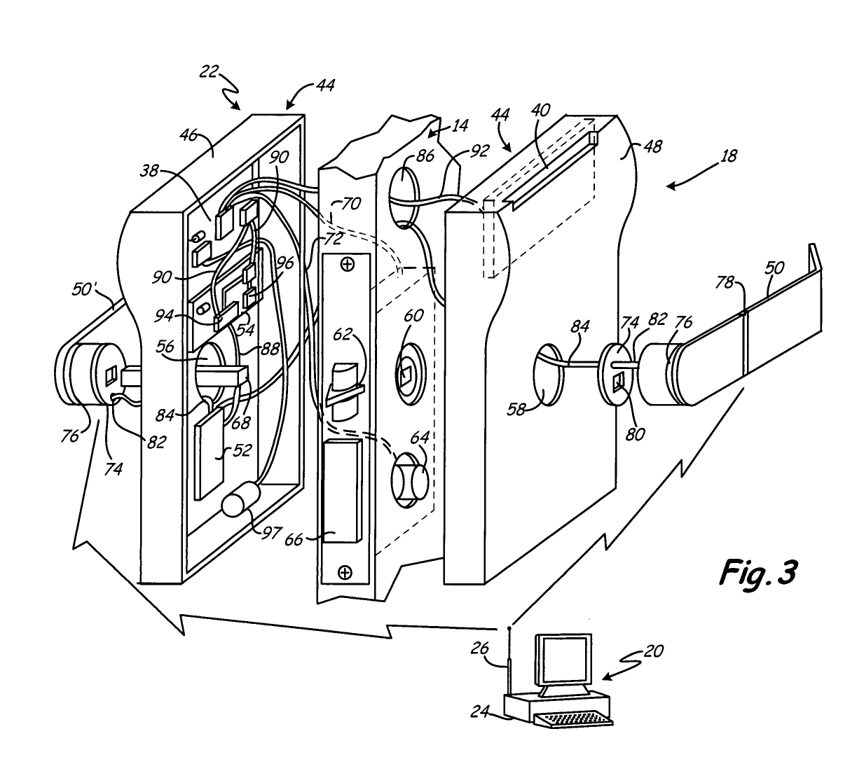

FIG. 3 shows an exploded perspective view of lock mechanism 18 which is mounted to door 14 (FIG. 1). Remote access control system 22 is positioned within lock mechanism 18 to control the locking and unlocking of lock mechanism 18. Remote access control system 22 includes remote access controller 38, key reader 40, housing 44, first plate 46, second plate 48, handles 50 and 50′, impedance matching network 52, and transmitter/receiver or transceiver circuit 54. Housing 44 has first plate 46 and second plate 48 that come together to be mounted on door 14. First plate 46 can act as a radiating device and mounts remote access controller 38, impedance matching network 52, and transceiver circuit 54 to door 14. Second plate 48 mounts key reader 40 to door 14. Each plate also mounts handle 50 and 50′ to door 14.

When first and second plate 46 and 48 come together to form housing 44, holes 56 and 58 accommodate lock mechanism 18, which is mounted to door 14 and is used to latch and lock door 14. Lock mechanism 18 includes handles 50 and 50′, latch retractor assembly 60, latch 62, deadbolt actuator 64, deadbolt 66, and spindle 68. Lock mechanism 18 is operated by actuating either of the handles 50 and 50′ in order to rotate latch retractor assembly 60 which is connected to latch 62. Latch retractor assembly 60 is electrically connected to remote access controller 38 through wire 70 so that control signals from remote access controller 38 can be sent to latch retractor assembly 60 to move latch retractor assembly 60 back and forth from an unlocked to a locked state. In the unlocked state, latch retractor assembly 60 can be operated by either handle 50 and 50′ to retract latch 62 from its extended position (shown in FIG. 3) engaging a door frame to its retracted position (not shown) inside door 14 and disengaging the door frame. Lock mechanism 18 also may include deadbolt actuator 64 and deadbolt 66. Deadbolt actuator 64 is electrically connected to remote access controller 38 through wire 72, so that control signals from remote access controller 38 can be sent to deadbolt actuator 64 to move deadbolt actuator 64 back and forth between an unlocked and a locked state. In the unlocked state, deadbolt actuator 64 is rotated or manipulated such that deadbolt 66 is in a retracted position (shown in FIG. 3) disengaging the door frame. In the locked state, deadbolt actuator 64 is rotated or manipulated such that deadbolt 66 is in an extended position and engages the door frame so that door 14 cannot be accessed, regardless of whether latch retractor assembly 60 is in an unlocked or locked state. Although the two forms of locks on lock mechanism 18 are mortise and deadbolt, lock mechanism 18 can include any type of lock that is suitable to secure door 14.

Spindle 68 is configured to extend through latch retractor assembly 60 and connect handles 50 and 50′ together. When latch retractor assembly 60 is in the unlocked state, rotation of either handle 50 and 50′ rotates spindle 68 which then rotates latch retractor assembly 60 to move latch 62 into its retracted position.

Handles 50 and 50′ form an external portion of lock mechanism 18 and can be used mechanically to operate lock mechanism 18 between the unlocked state and the locked state. However, one or both handles 50 and 50′ are also used electrically as antennas. Handles 50 and 50′ are typically fashioned out of metals or other material that acts as a conductive element and has low resistance. Handles 50 and 50′ such as shown in FIG. 3 also have an appreciable length and have a distinctive “L” shape, which extends them away from the remainder of lock mechanism 18 and door 14 into free space. Other types and shapes of door handles can also be used as antennas. It has been found that handles 50 and/or 50′ are quite conductive and are of sufficient length to radiate efficiently in the 400 MHz, 900 MHz, and 2 GHz bands. Ideally the length of handles 50 and/or 50′ is equal to or above a quarter of the wavelength of a lowest frequency band selected for system 10. In other embodiments, the handles 50 and 50′ can be adapted to radiate effectively in many other bands, for example, between the 300 MHz to 10 GHz bands.

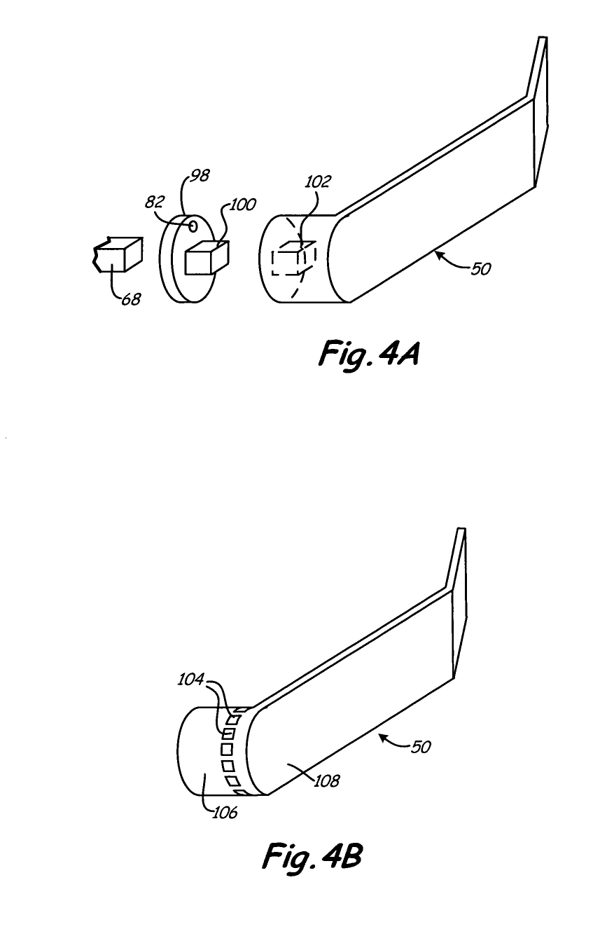

In order for handles 50 and 50′ to have the dual purpose of mechanically operating door 14 and electrically operating as antennas, they should be electrically isolated from the rest of the metal that may be present in housing 44 and door 14, for best efficiency. FIG. 3 shows three possible spots on each handle 50 and 50′ that could be used for electrical isolation. A typical way to “break” the electrical connection is to add one or two of three insulating pieces 74, 76, and 78 to handles 50 and 50′. Insulating pieces 74 are in particularly good spots on handles 50 and 50′, because they are closest to door 14 and that allows handles 50 and 50′ to have a longer effective antenna length. Insulating pieces 74, 76, and 78 may be made out of a strong polymer such as nylon or Delrin®, or any other strong fire retardant polymer. In FIG. 3, insulating piece 74 has spindle hole 80 to accommodate spindle 68. In this case, spindle 68 should also be made out of a material that does not electrically conduct between handles 50 and 50′. There are other ways to connect handles 50 and 50′ and isolate them electrically; several more examples can be seen in FIGS. 4A and 4B.

The use of one or both handles 50 and 50′ as antennas for remote access control system 22 using radio frequency (RF) signals leads to an increase in robustness and communication range of door security system 10 while maintaining the aesthetics of door 14. This increase in robustness and communication range is due to the antenna(s) forming an externally exposed portion of the lock mechanism 18 (i.e. the antenna is not housed within the lock mechanism 18 or a cavity of door 14 either of which can act as a barrier to efficient EM radiation). The increase in communication range means that fewer repeaters 30 need to be used.

Using both handles 50 and 50′ also can greatly reduce the effects of multipath. Multipath is a phenomenon where radio signals reach a receiving antenna by two or more paths. The undesirable effects of multipath include destructive interference, causing phase cancelation and/or reduction of the radio signal. Because both handles 50 and 50′ are able to act as antennas, a radio signal is not limited to one antenna mounted on door 14; the two antennas inches away from one another can switch receiving duties or operate simultaneously to reduce any multipath effects.

Insulating piece 74 also has wire hole 82 so that wires 84 can electrically connect handles 50 and 50′ to impedance matching network 52; wires 84 can go through any hole in door 14 that is suitable to reach impedance matching network 52, such as holes 56, 58, and 86. Impedance matching network 52 is then electrically connected by wire 88 to transceiver circuit 54, which is electrically connected to remote access controller 38 by wire 90. As is well known in the art, impedance matching network 52 operates to adjust the load (antenna) impedance relative to the source (transceiver) impedance such that the load (antenna) impedance is matched to the source (transceiver) impedance (i.e. in a low-frequency or DC system the resistance if the load is equal to the resistance of the source). In this manner, the maximum possible power is transferred from the transceiver to the antenna and from the antenna to the transceiver in the case of receiving.

Further shown in FIG. 3 is wire 92 extending through hole 86 and electrically coupling remote access controller 38 and key reader 40. Transceiver 54 is used to communicate (i.e. transmit and receive) information between remote access controller 38 and central wireless communicator 26 through handles 50 and 50′ acting as antennas. Transceiver 54 includes transmitter 94 and receiver 96. Remote access controller 38 can transmit information through transmitter 94 and handles 50 and 50′ to central wireless communicator 26. Conversely, wireless information transmitted by central access controller 24 through central wireless communicator 26 can be received by remote access controller 38 through handles 50 and 50′ and receiver 96. Battery 97 may be added to power remote access controller 38, deadbolt actuator 64, and key reader 40.

FIG. 4A shows another way of isolating handle 50 and 50′ electrically from the other metal of the lock mechanism 18 and remote access control system 22. Insulating sleeve 98 includes spindle cavity 100 that is configured to receive spindle 68. Handle 50 and 50′ includes insulating sleeve cavity 102 that is configured to receive insulating sleeve 98. Insulating sleeve 98 still includes wire hole 82 so that handle 50 and 50′ can communicate electrically as an antenna with remote access controller 38. Insulating sleeve 98 also forms a capacitor which can be used as part of an impedance matching network to the antenna/handle.

FIG. 4B is yet another way of isolating handle 50 and 50′ electrically from the other metal components in remote access control system 22 and lock mechanism 18. Handle 50 and 50′ includes rectangular openings 104 in its metal exterior thus forming an inductive connection “electrically” isolating first handle piece 106 and second handle piece 108 at the wavelength of choice. Again, rectangular openings 104 form an inductive component which in part can be part of an impedance matching network to the antenna/handle.

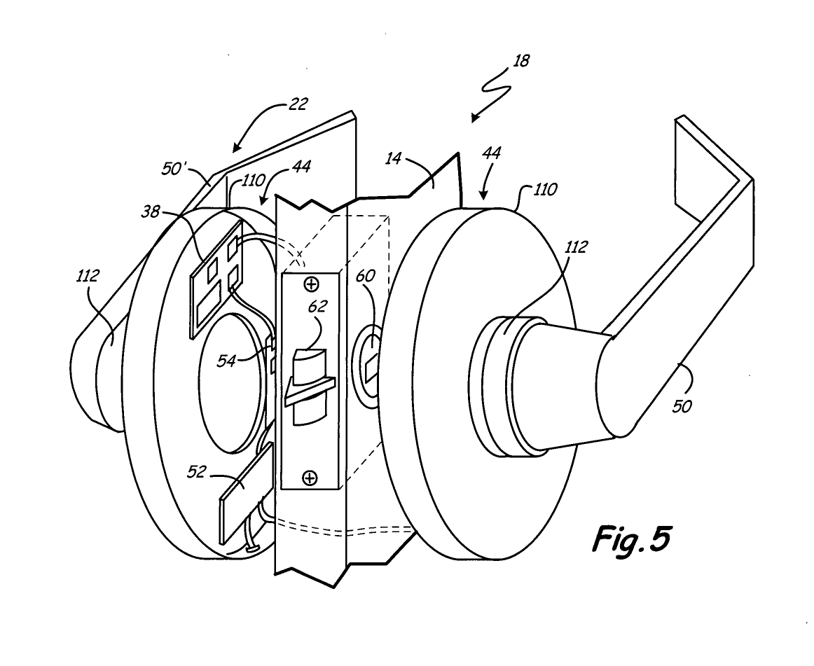

FIG. 5 is another embodiment of remote access control system 22 similar to the one shown in FIG. 3. Accordingly, the discussion of how lock mechanism 18 works will be left out. In FIG. 5, escutcheons 110 are used to put together housing 44 instead of plates with key reader 40. Escutcheons 110 extend externally away from door 14 (FIG.

1) and the remainder of lock mechanism 18 into an area of free space and can be circular, oblong, or otherwise any other shape suitable for mounting remote access control system 22 to door 14. This time, however, escutcheons 110 are used as antennas to communicate with remote access controller 38 instead of handles 50 and 50′. Therefore, escutcheons 110 should be electrically isolated from the other metal components of remote access control system 22 for best performance. Insulating sleeves 112 which are fashioned to connect handles 50 and 50′ into escutcheons 110 electrically isolate escutcheons 110 while allowing handles 50 and 50′ to be mechanically connected to lock mechanism 18 and allowing handles 50 and 50′ to access door 14.

In both embodiments in FIG. 3 and FIG. 5, it is important to note that many security systems that either would like to utilize wireless technology in the future or already do use wireless technology would benefit from the aesthetic appeal of using existing metal structures such as the handles and escutcheons as the antenna(s) for wireless communication. These existing metal structures have an appreciable mass and length that are suitable for use as antennas; they also are external to the door and form an external portion of the lock mechanism which projects away from the door into free space, improving effectiveness as an antenna consequently reducing the need for repeaters.

Although the present invention has been described with reference to preferred embodiments, workers skilled in the art will recognize that changes may be made in form and detail without departing from the spirit and scope of the invention.

1. An antenna for a door lock mechanism, comprising:
a conductive element that is adapted as at least one of a door handle or an escutcheon of the lock mechanism, the conductive element forming an external portion of the lock mechanism and operable to either receive or transmit control signals.

2. The antenna of claim 1, wherein the control signals are radio frequency signals and the conductive element is operable to both receive and transmit radio frequency signals at one or more bands.

3. The antenna of claim 2, wherein the conductive element is configured to radiate in a range from about 300 MHz to about 5.8 GHz.

4. The antenna of claim 1, wherein the conductive element communicates with the lock mechanism to switch the lock mechanism between an unlocked state and a locked state.

5. The antenna of claim 1, wherein the conductive element comprises a first handle and a second handle of the lock mechanism.

6. The antenna of claim 1, wherein the conductive element is electrically isolated from the remainder of the lock mechanism by an insulating sleeve or insulating piece or by an inductive connection.

7. A door security system comprising:
a lock mechanism operable between an unlocked state and a locked state, the lock mechanism including a handle or escutcheon configured as an antenna; and
a remote access control system at least partially disposed within the lock mechanism, the remote access control system responsive to control signals received by the antenna to switch the lock mechanism between the unlocked and locked state.

8. The door security system of claim 7, wherein the remote access control system both receives and transmits radio frequency signals.

9. The door security system of claim 8, wherein the radio frequency signals are in the range from about 300 MHz to about 5.8 GHz.

10. The door security system of claim 7, wherein the remote access control system includes a remote access controller and the antenna communicates with the remote access controller through an impedance network and a transceiver.

11. The door security system of claim 7, wherein the handle assembly further includes a key reader operable with the remote access control system.

12. The door security system of claim 7, wherein the handle or escutcheon is electrically isolated from a remainder of the lock mechanism.

13. The door security system of claim 7, wherein the handle includes a first handle and a second handle.

14. A method of communicating information to and/or from a lock mechanism, comprising:
providing the lock mechanism with either a handle or escutcheon configured as an antenna;
transmitting radio frequency signals from a central control module to the antenna; and
communicating the radio frequency signals received by the antenna to a remote access control system which operates the lock mechanism in response thereto.

15. The method of claim 14, further comprising:
communicating information from the remote access control system to the antenna; and
transmitting information as the radio frequency signals from the antenna to the central control module.

16. The method of claim 14, wherein the remote access control system includes a remote access controller and the antenna communicates with the remote access controller through an impedance network and a transceiver.

17. The method of claim 14, wherein the remote access control system is in electrical communication with the lock mechanism.

18. The method of claim 14, wherein the radio frequency signals are in the range from about 300 MHz to about 5.8 GHz.
